(19) United States
(12) Patent Application Publication
(10) Pub. No.: US 2003/0178854 A1
(43) Pub. Date: Sep. 25, 2003

(54) Energy conversion method

(76) Inventor: Alexandr Nikolaevich Dashkov, Vladivostok (RU)

Correspondence Address: Andrey Ermolinski, PO Box 35 94, Vladivostok, 690035, RU

(21) Appl. No.: 10/362,991

(22) PCT Filed: Sep. 3, 2001
(86) PCT No.: PCT/RU01/00362

(30) Foreign Application Priority Data
Sep. 4, 2000 (RU) 2000123043

(51) Int. Cl. H02P 9/04

(52) U.S. Cl. 290/5

(57) ABSTRACT

The invention can be used for wind power and hydro power engineering for the provision of an additional supply of additional supply AC electric energy and other types of energy such as heat energy to consumer. The aim of said invention is to increase the efficiency factor of an electric power installation whose motor has a variable frequency and/or a variable shaft power. The inventive energy conversion method can be used first and foremost for a non-autonomous electric power installation whose motor shaft is mechanically connected to rotors of at least two electric generators (1, 2) having correspondingly n-phase and m-phase stator windings (n can not be equal to m). A part of electric energy produced by the windings can be converted into another type of energy in an electric energy storage device (12). A part of electric energy produced by at least one generator (1, 2) can be supplied to a consumer only when the rotor speed corresponds to the frequency of current used by the consumer and produced by windings (3-5). The stabilisation of said rotor speed is carried out by breaking or terminating and varying the current sink on the electric energy storage device (12) simultaneously for all phases of at least one generator which is connected to the consumer, and/or of individual phases of at least one generator which is disconnected from the customer.

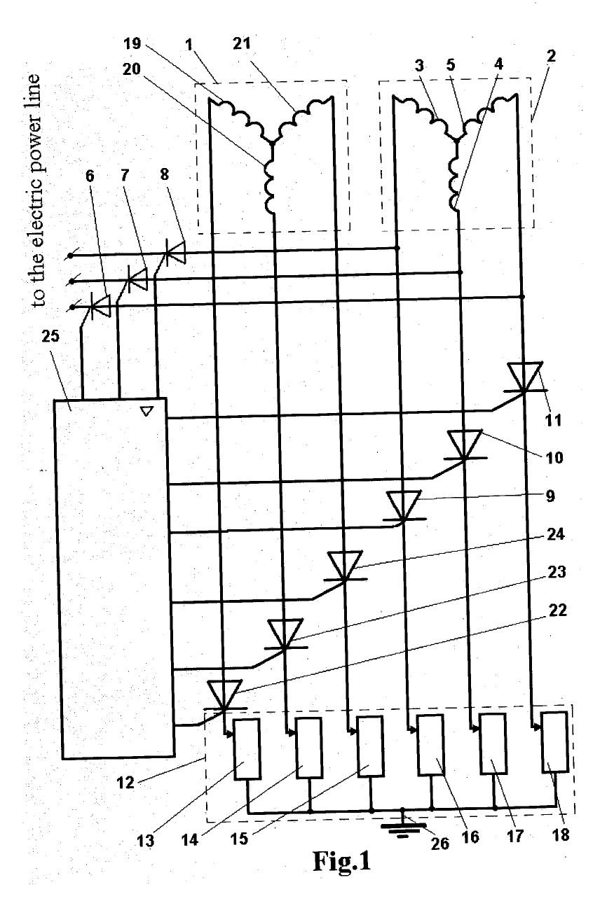

### TECHNICAL FIELD

The invention relates to electric power engineering and can be used in wind power and hydro power plants for the provision of an additional supply AC electric energy and other types of energy such as heat energy to consumer.

### BACKGROUND ART

The known energy conversion methods of a power plant with non-constant power and/or shaft rotation frequency (in particular, wind-power plant), for bringing the frequency of the current generated by the generator into agreement with the industrial power frequency, suggest usage of special frequency converters and/or inverters [patent RU2132483, 1999], as well as other auxiliary devices, for example, the ones adjusting the angle of wind incidence [patent RU2099590, 1997]. Nevertheless, such auxiliary devices make the design complex and reduce the efficiency of the power plant.

As a prototype, the method is chosen for energy conversion of an engine of a wind-power plant with non-constant power and/or shaft rotation frequency, the shaft being mechanically connected with the rotor of the electric generator having a n-phase stator winding. According to this method, a part of electric power is transferred from the windings to consumers, and a part of it can be converted into energy of another type in the accumulating device, the electrolyzer [patent RU2015412, 1994]. As well, the device implementing the method contains a frequency converter, has complex design and low efficiency.

### DISCLOSURE OF THE INVENTION

The technical task being solved is increasing of power plant efficiency with non-constant power and/or shaft rotation frequency.

The energy conversion method proposed can be realized preferably for a non-autonomous power plant of which the engine shaft is mechanically connected to rotors of at least two electric generators containing n-phase and m-phase stator windings, respectively (n can be non-equal to m). A part of electric power from the windings can be converted into energy of another type in the accumulating device. A part of the electric power produced at least by one of the generators, can be transferred to consumers only at the rotor rotation frequency which is equal to the current frequency consumed from the windings. Stabilization of the rotation frequency is accomplished by means of accumulation device load switching on and off and by changing the accumulation device load from all phases of at least one of the generators connected to consumers at the same time, and/or single phases of at least one of the generators disconnected from the consumers.

Connecting and disconnecting of consumers and/or the accumulation device load can be carried out by means of processor-operated thyristors, on the basis of the data from minimum one current frequency gauge or rotation frequency gauge.

A part of electric power can be converted in the accumulating device into heat energy, for example by means of heating elements immersed into a heat-carrying liquid, and control upon the accumulating device load can be carried out by means of adjusting the resistance of the heating elements. In the case when the heating elements are made in the form of conducting parallel plates, it is better to carry out the load adjustments by means of changing the clearance between the plates (immersed into the heat-carrying liquid).

### BRIEF DESCRIPTION OF THE FIGURES ON THE DRAWINGS

The invention is illustrated by the scheme design of the auxiliary energy plant, presented on one FIGURE.

### THE EXAMPLE FOR CARRYING OUT THE INVENTION

The Wind-Power Plant (WPS) contains two 3-phase electric generators 1 and 2 of which the rotors are rigidly fixed mechanically to the wind engine shaft (not shown). The power of the generator 1 is equal to ⅓ of that of the generator 2. (In the general case it is better if the power of a winding of one generator equals to the power of one phase of another generator). The phases 3-5 of the windings of the stator of the generator 2 are connected, through the thyristors 6-8, to the power mains, and, through the thyristors 9-11, to plate-shaped water-heater 12, of which the clearance between the pairs of plates 13-18 can be adjusted. The phases 19-21 of the generator 1, through the thyristors 22-24, are connected to the plates 13-15. As well, the installation is furnished with the shaft rotation frequency gauge (not shown) connected to the processor 25 which controls the thyristors 6-8, 9-11 and 22-24, and the mechanism regulating the clearance between the plates 13-18 (not shown), which are connected to the phases 3-5, 19-21, and the plates connected to the mains common wire 26.

The WPS works the following way. When the weather is windless, the wind-engine shaft does not rotate and all the thyristors 6-8, 9-11 and 22-24 are OFF. When some wind occurs, the wind-engine shaft begins rotations in the idle regime. Having reached the rotation frequency consistent with the electric current frequency of 50 Hz, on the command signal of the rotation frequency gauge, the processor 25 turns the thyristor 22 ON connecting the phase 19 to the plates 13 of the water-heater 12, the clearance between the plates being maximal. Under further increase of the rotation frequency its braking stabilization is carried out, on the processor 25 command signal, by means of narrowing the clearance between the plates 13 by the regulating mechanism. After the clearance between the plates 13 have reached its minimum, when the frequency of shaft rotation still exceeds the required frequency, the processor 25 connects the phase 20, by the thyristor 23, to the plates 14 of the water-heater 12, and the rotation frequency is stabilized the same way as for the phase 20. Further, as the power on the wind-engine shaft (and the rotation frequency) rise, the third phase 21 of the generator 1 is connected to the water-heater 12. After the power produced by all the phases 19-21 of the generator 1 have reached its nominal value, the processor 25, by means of the thyristors 22-24 disconnects the phases 19-21 from the water-heater 12 and, as the wind load rise, by means of the thyristors 9-11 consequently connects the phases 3-5 of the generator 2 to the plates 16-18 of the water-heater 12. After the power produced by all the phases 3-5 of the generator 2 have reached its nominal value, by means of the thyristors 9-11 and 6-8 it is switches on the electric power supply to the consumer system, and as the wind load rises stabilization of the rotation frequency is carried out by means of consequent connecting of the phases 19-21 of the generator 1 to the water-heater 12. If the electric power is not consumed in the power system the both generators are connected to the water-heater 12. While the wind load is falling the processor runs the process of the phases 3-5 and 19-21 control in the backward order. A WPS can have more generators than two; then the wind load range enlarges, the electricity supply time and the amount of the power supplied to consumers grow as well.

### Industrial Applicability

The WPS can be used in wind- or hydro-power systems as an auxiliary power plant.

I claim:

1. A method of conversion of a power plant engine whose power and/or shaft rotation frequency are not constant, the shaft being mechanically fixed to a rotor of minimum one electric generator having a n-phase stator winding, when some part of the electric energy is transferred from the windings to consumers and some other part of it can be conversed into another type of energy in the accumulating device, distinctive in that as a non-autonomous power plant works containing not less than two generators, the other generator being connected to the engine shaft as well and it can have another number m of winding phases, power supply to consumers from a winding of at least one generator is carried out only at the rotor rotation frequency which corresponds with the frequency of the consumed current obtained from windings, and stabilization of this rotation frequency is accomplished by means of switching OFF or ON and adjusting of the accumulating device load concurrently from all the windings of at least one generator, at the same time connected to the consumer, and/or single phases of at least one generator disconnected from the consumer.

2. The method of claim 1, wherein the switching ON and OFF of the accumulating device load is carried out by thyristors controlled by a processor on the basis of the data from at least a rotation frequency gauge or a current frequency gauge.

3. The method of claim 1, wherein the switching ON and OFF of the consumer is carried out by thyristors controlled by a processor on the basis of the data from at least a rotation frequency gauge or a current frequency gauge.

4. The method of claim 1, wherein some part of the electric power is converted in the accumulating device into the heat.

5. The method of claim 4, wherein the conversion into the heat is carried out by means of heating elements immersed in liquid.

6. The method of claim 5, wherein the adjusting of the accumulating device load is carried out by means of adjusting the resistance of the heating elements.

7. The method of claim 6, wherein the adjusting of resistance of the conductive parallel-plate-shaped heating elements is carried out by means of adjusting the distance between the conducting plates.
